(19) United States
(12) Patent Application Publication
(10) Pub. No.: US 2024/0240581 A1
(43) Pub. Date: Jul. 18, 2024

(54) HONEYCOMB STRUCTURE, ELECTRICALLY HEATING SUPPORT AND EXHAUST GAS TREATMENT DEVICE

(71) Applicants: NGK INSULATORS, LTD., Nagoya-Shi (JP); TOYOTA JIDOSHA KABUSHIKI KAISHA, Toyota-Shi (JP)

(72) Inventors: Yuko KOZAKI, Inazawa-Shi (JP); Kazumi MASE, Shenzhen (CN); Takahiro SADAMITSU, Miyoshi-Shi (JP); Shinobu SHIMASAKI, Toyota-Shi (JP)

(73) Assignees: NGK INSULATORS, LTD., Nagoya-Shi (JP); TOYOTA JIDOSHA KABUSHIKI KAISHA, Toyota-Shi (JP)

(21) Appl. No.: 18/534,842

(22) Filed: Dec. 11, 2023

(30) Foreign Application Priority Data
Jan. 13, 2023 (JP) 2023-003987

(51) Int. Cl. F01N 3/28; F01N 3/20

(52) U.S. Cl. CPC F01N 3/2828; F01N 3/2026; F01N 2330/06; F01N 2330/30

(57) ABSTRACT

A honeycomb structure includes: a honeycomb structure portion 1 made of ceramics, the honeycomb structure portion 1 including an outer peripheral wall 10, a partition wall 11defining a plurality of cells 11a, and a plurality of slits 12 cut inwardly in a radial direction from the outer peripheral wall 10; a pair of electrode layers 2 being provided on an outer surface of the outer peripheral wall 10 so as to face each other across a central axis CA of the honeycomb structure portion 1; and reinforcing layers 3 provided on the outer surface of the outer peripheral wall 10 so as to be located between the pair of electrode layers 2 in a circumferential direction 1C of the honeycomb structure portion 1, the reinforcing layers 3 being electrically separated from the pair of electrode layers 2 by the slits 12.

### FIELD OF THE INVENTION

The present invention relates to a honeycomb structure, an electrically heating support, and an exhaust gas treatment device.

### BACKGROUND OF THE INVENTION

As shown in Patent Literatures 1 and 2 as described below, electrically heating catalysts (EHCs) are known. The EHC has electrodes provided on an outer periphery of a honeycomb structure made of conductive ceramics, and heat the honeycomb structure itself by electric conduction to increase a temperature of a catalyst supported on the honeycomb structure to its activation temperature before starting an engine. There is a need for the honeycomb structure to not crack due to a change of a temperature of an exhaust gas in order not to interrupt an electric conduction path within the honeycomb structure and to prevent the honeycomb structure from falling off.

### CITATION LIST

### Patent Literatures

[Patent Literature 1] Japanese Patent No. 5,663,003 B
[Patent Literature 2] Japanese Patent No. 6,126,434 B

### SUMMARY OF THE INVENTION

When an exhaust gas at elevated temperature enters the honeycomb structure at a low temperature, a temperature difference tends to occur between a central portion and an outer peripheral portion of end faces of the honeycomb structure due to a flow velocity distribution. In general, the center portion of the honeycomb structure tends to be hotter than the outer peripheral portion. When such a temperature difference occurs, stress that induces cracks extending in the axial direction (vertical cracks) in the outer peripheral portion is generated in the honeycomb structure due to a difference in thermal expansion of the honeycomb structure.

The present invention has been made to solve the above problems. One of objects of the present invention is to provide a honeycomb structure, an electrically heating support, and an exhaust gas treatment device, which can suppress the generation of vertical cracks extending in the axial direction.

### Aspect 1.

In an embodiment, the present invention relates to a honeycomb structure comprising: a honeycomb structure portion made of ceramics, the honeycomb structure portion comprising an outer peripheral wall, a partition wall disposed on an inner side of the outer peripheral wall, the partition wall defining a plurality of cells, each of the cells extending from one end face to other end face to form a flow path, and a plurality of slits cut inwardly in a radial direction from the outer peripheral wall, each of the slits extending in an extending direction of the cells; a pair of electrode layers used for passing a current into and out of the honeycomb structure portion, the pair of electrode layers being provided on an outer surface of the outer peripheral wall so as to face each other across a central axis of the honeycomb structure portion; and reinforcing layers provided on the outer surface of the outer peripheral wall so as to be located between the pair of electrode layers in a circumferential direction of the honeycomb structure portion, the reinforcing layers being electrically separated from the pair of electrode layers by the slits.

### Aspect 2.

The present invention may relate to the honeycomb structure according to Aspect 1, wherein the entire outer periphery of the outer peripheral wall is covered with the electrode layers and the reinforcing layers except for positions of the plurality of slits.

### Aspect 3.

The present invention may relate to the honeycomb structure according to Aspect 1 or 2, wherein the electrode layers and the reinforcing layers are made of the same material.

### Aspect 4.

The present invention may relate to the honeycomb structure according to any one of Aspects 1 to 3, wherein a ratio (R2/R1) of a volume resistivity (R2) of the reinforcing layers to a volume resistivity (R1) of the honeycomb structure is more than or equal to 0.0001 and less than or equal to 1 or less.

### Aspect 5.

The present invention may relate to the honeycomb structure according to any one of Aspects 1 to 4, wherein the number of the slits in regions where the reinforcing layers are provided is larger than the number of the slits in regions where the electrode layers are provided in the circumferential direction of the honeycomb structure portion.

### Aspect 6.

In an embodiment, the present invention relates to an electrically heating support comprising: the honeycomb structure according to any one of Aspects 1 to 5; and electrode terminals provided on the pair of electrode layers.

### Aspect 7.

In an embodiment, the present invention relates to an exhaust gas treatment device comprising: the electrically heating support according to Aspect 6; and a metal can for holding the honeycomb structure.

According to an embodiment of the honeycomb structure, the electrically heating support and the exhaust gas treatment device of the present invention, the reinforcing layers electrically separated from the pair of electrode layers by the slits are provided on the outer surface of the outer peripheral wall so as to be located between the pair of electrode layers in the circumferential direction of the honeycomb structure portion, so that the generation of vertical cracks extending in the axial direction can be suppressed.

### BRIEF DESCRIPTION OF THE DRAWINGS

FIG. 1 is a perspective view showing a honeycomb structure according to an embodiment of the present invention;

FIG. 2 is a front view showing the honeycomb structure in FIG. 1; and

FIG. 3 is an explanatory view showing an exhaust gas treatment device including the electrically heating support in FIG. 1.

### DETAILED DESCRIPTION OF THE INVENTION

Hereinafter, embodiments for carrying out the present invention will be described with reference to the drawings. The present invention is not limited to each embodiment, and components can be modified and embodied without departing from the spirit of the present invention. Further, various inventions can be formed by appropriately combining a plurality of components disclosed in each embodiment. For example, some components may be removed from all of the components shown in the embodiments. Furthermore, the components of different embodiments may be optionally combined.

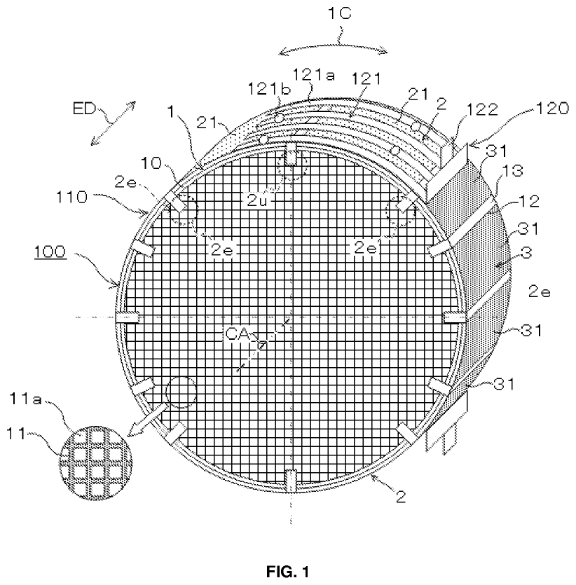

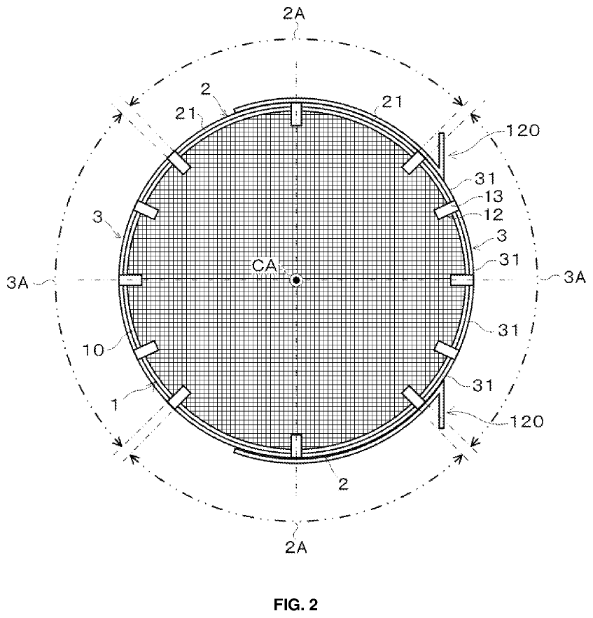

FIG. 1 is a perspective view showing an electrically heating support 100 according to an embodiment of the present invention, and FIG. 2 is a front view showing the electrically heating support 100 in FIG. 1. The electrically heating support 100 shown in FIG. 1 includes a honeycomb structure 110 and electrode terminals 120.

The honeycomb structure 110 includes a honeycomb structure 1, a pair of electrode layers 2, and reinforcing layers 3.

The honeycomb structure portion 1 is a pillar shaped member made of ceramics, and includes: an outer peripheral wall 10; and a partition wall 11 which is disposed on an inner side of the peripheral wall 10 and defines a plurality of cells 11a each extending from one end face to other end face to form a flow path. The pillar shape is understandable as a three-dimensional shape having a thickness in an extending direction ED of the cells 11a (axial direction of the honeycomb structure portion 1). A ratio of an axial length of the honeycomb structure portion 1 to a diameter or width of the end face of the honeycomb structure portion 1 (aspect ratio) is arbitrary. The pillar shape may also include a shape in which the axial length of the honeycomb structure portion 1 is shorter than the diameter or width of the end face (flat shape).

An outer shape of the honeycomb structure portion 1 is not particularly limited as long as it has a pillar shape. For example, it can be other shapes such as a pillar shape having circular end faces (cylindrical shape), a pillar shape having oval end faces, and a pillar shape having polygonal (rectangular, pentagonal, hexagonal, heptagonal, octagonal, etc.) end faces. As for the size of the honeycomb structure portion 1, an area of the end faces is preferably from 2,000 to 20,000 mm², and even more preferably from 5,000 to 15,000 mm², in order to increase heat resistance (to suppress cracks generated in the circumferential direction of the outer peripheral wall).

A shape of each cell 11a in the cross section perpendicular to the extending direction ED of the cells 11a may preferably be a quadrangle, hexagon, octagon, or a combination thereof. Among these, the quadrangle and the hexagon are preferred. Such a cell shape can lead to a decreased pressure loss when an exhaust gas flows through the honeycomb structure portion 1, which can provide improved purification performance. From the viewpoint of achieving both structural strength and heating uniformity, the quadrangular and hexagonal shapes are particularly preferred.

The partition wall 11 that defines the cells 11a preferably has a thickness of from 0.1 to 0.3 mm, and more preferably from 0.1 to 0.2 mm. The thickness of 0.1 mm or more of the partition wall 11 can suppress a decrease in the strength of the honeycomb structure portion 1. The thickness of the partition wall 11 of 0.3 mm or less can suppress a larger pressure loss when an exhaust gas flows through the honeycomb structure portion 1 if the honeycomb structure portion 1 is used as a catalyst support to support a catalyst. In the present invention, the thickness of the partition wall 11 is defined as a length of a portion passing through the partition wall 11, among line segments connecting the centers of gravity of adjacent cells 11a, in the cross section perpendicular to the extending direction ED of the cells 11a.

The honeycomb structure portion 1 preferably has a cell density of from 40 to 150 cells/cm², and more preferably from 70 to 100 cells/cm², in the cross section perpendicular to the extending direction ED of the cells 11a. The cell density in such a range can allow the purification performance of the catalyst to be increased while reducing the pressure loss when the exhaust gas flows. The cell density of 40 cells/cm² or more can allow a catalyst support area to be sufficiently ensured. The cell density of 150 cells/cm² or less can prevent the pressure loss when the exhaust gas flows through the honeycomb structure portion 1 from being increased if the honeycomb structure portion 1 is used as a catalyst support to support the catalyst. The cell density is a value obtained by dividing the number of cells by the area of one end face portion of the honeycomb structure portion 1 excluding the outer peripheral wall 10 portion.

The provision of the outer peripheral wall 10 of the honeycomb structure portion 1 is useful from the viewpoints of ensuring the structural strength of the honeycomb structure portion 1 and suppressing the leakage of fluid flowing through the cells 11a from the outer perimeter wall 10. Specifically, the thickness of the outer peripheral wall 10 is preferably 0.05 mm or more, and more preferably 0.10 mm or more, and even more preferably 0.15 mm or more. However, if the outer peripheral wall 10 is too thick, the strength will be too high, and a strength balance between the outer peripheral wall 10 and the partition walls 11 will be lost, resulting in a decrease in thermal shock resistance. Therefore, the thickness of the outer peripheral wall 10 is preferably 1.0 mm or less, and more preferably 0.7 mm or less, and even more preferably 0.5 mm or less. The thickness of the outer peripheral wall 10 is defined as a thickness of the outer peripheral wall in the normal line direction relative to the tangent line at a measured point when the point of the outer peripheral wall 10 where the thickness is to be measured is observed in the cross section perpendicular to the extending direction ED of the cells 11a.

The honeycomb structure portion 1 is made of ceramics and is preferably electrically conductive. Electric resistivity is not particularly limited as long as the honeycomb structure portion 1 is capable of heat generation by Joule heat when a current is applied. Preferably, the electric resistivity is from 0.1 to 200 Ωcm, and more preferably from 1 to 200 Ωcm. As used herein, the electric resistivity of the honeycomb structure portion 1 refers to a value measured at 25° C. by the four-terminal method.

The honeycomb structure portion 1 can be made of a material selected from non-oxide ceramics such as silicon carbide, silicon nitride and aluminum nitride, although not limited thereto. Further, silicon carbide-metal-silicon composites and silicon carbide/graphite composites can also be used. Among these, it is preferable that the material of the honeycomb structure portion 1 contains ceramics mainly based on a silicon-silicon carbide composite material or silicon carbide, in terms of balancing heat resistance and electrical conductivity. The phrase “the material of the honeycomb structure portion 1 is mainly based on silicon-silicon carbide composite material” means that the honeycomb structure portion 1 contains 90% by mass of more of silicon-silicon carbide composite material (total mass) based on the total material. Here, the silicon-silicon carbide composite material contains silicon carbide particles as an aggregate and silicon as a binding material to bind the silicon carbide particles, preferably in which a plurality of silicon carbide particles are bound by silicon such that pores are formed between the silicon carbide particles. The phrase “the material of the honeycomb structure portion 1 is mainly based on silicon carbide” means that the honeycomb structure portion 1 contains 90% or more of silicon carbide (total mass) based on the total material.

When the honeycomb structure portion 1 contains the silicon-silicon carbide composite material, a ratio of the “mass of silicon as a binding material” contained in the honeycomb structure portion 1 to the total of the “mass of silicon carbide particles as an aggregate” contained in the honeycomb structure portion 1 and the “mass of silicon as a binding material” contained in the honeycomb structure portion 1 is preferably from 10 to 40% by mass, and more preferably from 15 to 35% by mass.

The partition wall 11 may be porous. When the partition wall 11 is porous, the porosity of the partition wall 11 is preferably from 35 to 60%, and even more preferably from 35 to 45%. The porosity is a value measured by a mercury porosimeter.

The partition wall 11 of the honeycomb structure portion 1 preferably has an average pore diameter of from 2 to 15 μm, and even more preferably from 4 to 8 μm. The average pore diameter is a value measured by a mercury porosimeter.

The honeycomb structure portion 1 has a plurality of slits 12 which are spaced apart from each other in a circumferential direction 1C of the honeycomb structure portion 1 and cut inwardly in the radial direction from the outer peripheral wall 10, and which extend in the extending direction ED of the cells 11a. Each of the slits 12 according to this embodiment extends straightly in the extending direction ED from one end face to the other end face of the honeycomb structure portion 1. As used herein, a gap between each electrode layer 2 and each0 reinforcing layer 3, which will be described later, is also referred to as the slit 12.

The slits 12 may be voids, but they may be filled with a filling material 13. The filling material 13 is filled in at least a part of a space of each slit 12. The filling material 13 is preferably filled in 50% or more of the space of each slit 12, and the filling material 13 is more preferably filled in the entire space of each slit 12. In the embodiment as shown in FIG. 1, the filling material 13 is filled in the entire space of each slit 12 to form a plane integrated with both end faces of the honeycomb structure portion 1 and a curved surface integrated with the outer surfaces of the electrode layers 2 and the reinforcing layers 3. However, the filling material 13 may be filled to a position on an axially inner side than the end faces of the honeycomb structure portion 1, or may be filled to a position on an inner side in a radial or width direction than the electrode layers 2 and the reinforcing layers 3 or the outer peripheral wall 10 of the honeycomb structure portion 1.

When the main component of the honeycomb structure portion 1 is silicon carbide or metal silicon-silicon carbide composite, the filling material 13 preferably contains at least 20% by mass silicon carbide, and more preferable from 20 to 70% by mass of silicon carbide. This can allow a thermal expansion coefficient of the filling material 13 to be close to that of the honeycomb structure portion 1, thereby improving the thermal shock resistance of the honeycomb structure portion 1. The filling material 13 may contain 30% by mass or more of silica, alumina, or the like.

The pair of electrode layers 2 and the reinforcing layers 3 are provided on the outer surface of the outer peripheral wall 10 of the honeycomb structure portion 1. In order to facilitate understanding, the electrode layer 2 and the reinforcing layer 3 are shown with different shades from each other in FIG. 1.

In particular, as shown in FIG. 2, the pair of electrode layers 2 are provided to face each other across a central axis CA of the honeycomb structure portion 1. Electrode terminals 120 are attached to the pair of electrode layers 2, respectively, and an external power source is connected through the electrode terminals 120. The pair of electrode layers 2 are used for passing current into and out of the honeycomb structure portion 1. One of the pair of electrode layers 2 is understandable as a positive electrode layer, and the other is understandable as a negative electrode layer.

In this embodiment, the pair of electrode layers 2 (the positive electrode layer and the negative electrode layer) each has a pair of partial electrode layers 21 separated from each other by the slits 12. In each of the positive electrode layer and the negative electrode layer, an electrode terminal 120 is attached so as to straddle the pair of partial electrode layers 21. In other words, the pair of partial electrode layers 21 are electrically handled as one unit. The slits 12 between the partial electrode layers 21 are provided mainly to relieve thermal stress. It is preferable that the slits 12 between the partial electrode layers 21 be provided at positions that do not interrupt the flow of electricity.

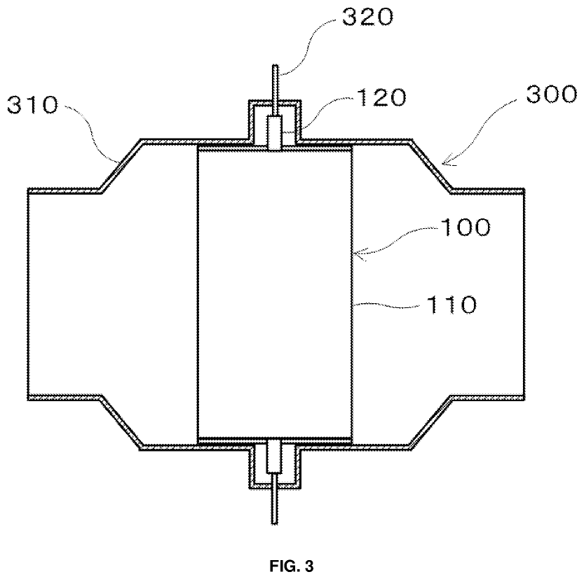

As particularly shown in FIG. 1, each electrode terminal 120 has a connecting portion 121 disposed on an outer surface of each electrode layer 2 and a drawer portion 122 provided at one end of the connecting portion 121. The connecting portion 121 is electrically connected to the electrode layer 2. An external power source is connected to the drawer portion 122 via a wire 320 (see FIG. 3 later).

As in the illustrated embodiment, the connecting portion 121 can have a comb-teeth shape having a plurality of teeth portions 121a spaced apart from each other in a width direction of the connecting portion 121. The width direction of the connecting portion 121 can extend parallel to the extending direction ED of the cells 11a, and the tooth portions 121a can have a longitudinal shape extending in the circumferential direction 1C of the honeycomb structure portion 1. The teeth portions 121a may be selectively connected to the partial electrode layer 21. In the illustrated embodiment, the respective tooth portions 121a are connected to different partial electrode layers 21 from one end to the other end in the width direction of the connecting portion 121. A contact portion 121b between each tooth portion 121a and the partial electrode layer 21 may be formed by any method. For example, the contact portion 121b may be formed by thermal spraying or welding.

The reinforcing layers 3 are provided on the outer surface of the outer peripheral wall 10 so as to be located between the pair of electrode layers 2 in the circumferential direction 1C of the honeycomb structure portion 1, and are electrically separated from the pair of electrode layers 2 by the slits 12. In other words, each slit 12 is provided between the electrode layer 2 and the reinforcing layer 3, and the electrode layer 2 and the reinforcing layer 3 are not directly adjacent to each other. The electrode terminal 120 is not attached to the reinforcing layer 3, and the reinforcing layer 3 is a portion that is not used for passing current into and out of the honeycomb structure portion 1. The reinforcing layer 3 is a portion that may be omitted if only the current flowing into and out of the honeycomb structure portion 1 is considered, and it may be a portion intentionally provided to reinforce the honeycomb structure 110.

The phrase “electrically separated” may be understandable that the electric resistance between the electrode layer 2 and the reinforcing layer 3 is higher than the case where the electrode layer 2 and the reinforcing layer 3 are provided in series or adjacent to each other. That is, a material having a higher electrical resistivity than the electrode layer 2 and the reinforcing layer 3 may be interposed between the electrode layer 2 and the reinforcing layer 3, and the electrode layer 2 and the reinforcing layer 3 may be physically separated. In this embodiment, the filling material 13, as the material having the higher electrical resistivity than the electrode layer 2 and the reinforcing layer 3, is interposed between the electrode layer 2 and the reinforcing layer 3. The electrode layer 2 and the reinforcing layer 3 may be electrically separated by a gap (air).

Each slit 12 between the electrode layer 2 and the reinforcing layer 3 may be filled with the filling material 13 as in this embodiment. The electrical resistivity of the filling material 13 is preferably 10 times or more, more preferably 100 times or more, and even more preferably 1000 times or more, the electrical resistivity of the honeycomb structure portion 1. The electrical resistivity of the filling material 13 can be set to be higher than that of the honeycomb structure portion 1. This is to ensure that the electrical resistance between the electrode layer 2 and the reinforcing layer 3 is increased. In the present invention, the electrical resistivity of the filling material 13 is a value measured at 25° C. using a four-probe method.

As illustrated, each of the reinforcing layers 3 may have a plurality of partial reinforcing layers 31 separated from each other by the slits 12.

As particularly shown in FIG. 1, the entire outer periphery of the outer peripheral wall 10 may be covered with the electrode layers 2 and the reinforcing layers 3 except for the positions of the plurality of slits 12. The electrode layers 2 and the reinforcing layers 3 are provided in the entire region between the slits 12 in the circumferential direction 1C, and are provided in the entire region between the edges of the honeycomb structure portion 1 in the extending direction ED of the cells 11a. However, the electrode layers 2 and the reinforcing layers 3 may be partially provided in at least one of the circumferential direction 1C and the extending direction ED of the cells 11a.

The electrode layer 2 and the reinforcing layer 3 may be made of different materials, or may be made of the same material. The electrical resistivity of the electrode layers 2 is preferably 1/10000 or more and 1-fold or less of that of the honeycomb structure portion 1, in terms of facilitating the flow of electricity to the electrode layers 2. More preferably, the electrical resistivity of the electrode layers 2 is 1/10000 or more and 1/10 or less. Each electrode layer 2 (and each reinforcing layer 3) may be made of conductive ceramics, a metal, or a composite material (cermet) of a metal and a conductive ceramic. Examples of the metal include a single metal of Cr, Fe, Co, Ni, Si or Ti, or alloys containing at least one metal selected from the group consisting of those metals. Non-limiting examples of the conductive ceramics include silicon carbide (SiC), and metal compounds such as metal silicides such as tantalum silicide (TaSi₂) and chromium silicide (CrSi₂).

Each of the electrode layer 2 and the reinforcing layer 3 preferably has a thickness of 0.01 to 5 mm, and more preferably 0.01 to 3 mm. Such a range allows a uniform heat generation property to be improved so that thermal shock resistance can be ensured. The thickness of each of the electrode layer 2 and the reinforcing layer 3 is defined as a thickness in a normal direction to a tangent line at a position where the thickness is to be measured on the outer surface of each of the electrode layer 2 and the reinforcing layer 3 when the measurement position is observed in a cross section perpendicular to the extending direction ED of the cells 11a.

As a method for producing the honeycomb structure 110 having the electrode layers 2 and the reinforcing layers 3, when the electrode layer 2 and the reinforcing layer 3 have the same composition, first, an electrode layer/reinforcing layer forming raw material containing ceramic materials is applied onto a side surface of a honeycomb dry body and dried to form unfired electrode layers and reinforcing layers on the outer surface of the outer peripheral wall 10 so as to extend in the form of band in the flow path direction of the cells 11a, across the central axis CA of the honeycomb dry body, thereby providing a honeycomb dried body with unfired layers. The resulting honeycomb dried body is then fired to produce a honeycomb fired body. In order to form the pair of electrode layers 2 and reinforcing layers 3 in the honeycomb fired body, a plurality of slits 12 are formed by making cuts inwardly in the radial direction from the outer peripheral surface, and the slits 12 are filled with a filling material 13. The honeycomb fired body in which the slits 12 are filled with the filling material 13 is subjected to a heat treatment to solidify the filling material 13. As a result, a honeycomb structure 110 having the electrode layers 2 and the reinforcing layers 3 is obtained. After forming the plurality of slits 12 in the honeycomb dried body and filling the slits 12 with the filling material 13, the honeycomb dried body may be fired to produce a honeycomb fired body having the pair of electrode layers 2 and the reinforcing layers 3.

When the electrode layer 2 and the reinforcing layer 3 have different compositions, the honeycomb structure 110 can be produced by the same method as described above, with the exception that the following honeycomb dried body is produced. An electrode layer forming raw material and a reinforcing layer forming raw material which contain ceramic raw materials are applied and dried to form unfired electrode layers and reinforcing layers on the outer surface of the outer peripheral wall 10 so as to extend in the form of band across the central axis CA of the honeycomb dried body in the flow path direction of the cells 11a, thereby producing a honeycomb dried body with unfired layers. It should be noted that the method for producing the honeycomb dried body can be performed according to a known method for producing the honeycomb structure 110.

The electrode layer/reinforcing layer forming raw material, the electrode layer forming raw material and the reinforcing material forming raw material can be formed by adding various additives to the raw material powder (metal powder, glass powder, and the like) formulated according to required characteristics of the electrode layers 2 and the reinforcing layers 3, and kneading them. Powder of a metal such as stainless steel can be used as the metal powder.

As a variation of the method for producing the honeycomb structure 110, the honeycomb dried body may be fired once before applying the electrode layer/reinforcing layer forming raw material. That is, in this variation, the honeycomb fired body is produced by firing the honeycomb dried body, and the electrode layer/reinforcing layer forming raw material is applied to the honeycomb fired body.

A plurality of slits 12 are formed by providing cuts inwardly in the radial direction from the outer peripheral surface of the honeycomb dried body with unfired layers. The slits 12 can be formed using a cutting tool or the like in accordance with a general method for forming the slits 12. It should be noted that the slits 12 may not be formed in the honeycomb dried body, and as described below, the slits 12 may be formed in the honeycomb fired body after the honeycomb fired body is produced by firing the honeycomb dried body.

The filling material 13 is filled by filling a material for the filling material in the slits of the honeycomb dried body (or the honeycomb fired body) and drying it. The filling material 13 can be filled by a known method such as press-fitting with a spatula. The raw material for the filling material is prepared by adding a binding material (metal silicon, etc.), a binder, a surfactant, a pore former, water, and the like to an aggregate (silicon carbide, etc.). The pore former used as the raw material for the filling material is not particularly limited as long as it forms pores after firing, and examples thereof include graphite, starch, foamed resins, water-absorbing resins, silica gel, and the like. The content of the pore former is preferably 0.1 to 20 parts by mass, more preferably 1 to 15 parts by mass, when the total mass of the aggregate and the binder is 100 parts by mass. The pore former preferably has an average particle size of 3 to 150 μm. As a method for heating the filling material 13, it is preferable to heat it at 400 to 700° C. for 10 to 60 minutes. The heating (heat treatment) is performed to strengthen the chemical bonds of the filling material 13. The heating method is not particularly limited, and the firing may be performed using an electric furnace, a gas furnace, or the like.

The firing conditions when the unfired honeycomb dried body with unfired layers is fired to produce a honeycomb fired body are: an inert gas atmosphere or an air atmosphere, an atmospheric pressure or less, a firing temperature of from 1150 to 1350° C., and a firing time of from 0.1 to 50 hours. The firing atmosphere can be, for example, an inert gas atmosphere, and the pressure during firing can be ambient pressure. In order to reduce the electrical resistance of the honeycomb structure portion 1, it is preferable to reduce the residual oxygen in terms of inhibited oxidation, and it is preferable to create a high vacuum of 1.0×10⁻⁴ Pa or more in the atmosphere during sintering and then purge the inert gas before sintering. The inert gas atmosphere includes a N₂ gas atmosphere, a helium gas atmosphere, an argon gas atmosphere, and the like. Before firing, the unfired honeycomb structure may be dried. Further, prior to the firing, degreasing may also be carried out to remove the binder and the like.

When the electrode layer 2 and the reinforcing layer 3 may be made of the same material, a ratio (R2/R1) of a volume resistivity (R2) of the reinforcing layers 3 to a volume resistivity (R1) of the honeycomb structure portion 1 is preferably more than or equal to 0.0001 and less than or equal to 1. The ratio (R2/R1) of more than or equal to 0.0001 can prevent the current from being deviated toward the outer peripheral portion of the honeycomb structure 1, so that the entire honeycomb structure 1 can more uniformly be heated. Specifically, as will be described below in detail in Examples, the deviation between the temperature of the honeycomb structure portion 1 at an end position 2e of the electrode layer 2 and the temperature of the honeycomb structure portion 1 at a directly-below position 2u of the electrode layer 2 can be suppressed. The ratio (R2/R1) less than or equal to 1 allows the current to be widely passed through the outer periphery of the honeycomb structure 1 as well. The ratio (R2/R1) can be adjusted by changing the materials and/or thicknesses of the honeycomb structure portion 1 and the reinforcing layer 3. As described above, the material of the reinforcing layer 3 may be different from that of the electrode layer 2, and in this case, the ratio (R2/R1) may exceed 1, for example, 5000 or less, or 1000 or less.

As in the illustrated embodiment, the number of the slits 12 in regions 3A where the reinforcing layers 3 are provided can be larger than the number of the slits 12 in regions 2A where the electrode layers 2 are provided in the circumferential direction 1C of the honeycomb structure portion 1. In the illustrated embodiment, the number of the slits 12 in the regions 2A where the electrode layers 2 are provided is two, and the number of the slits 12 in the regions 3A where the reinforcing layers 3 are provided is six. The slits 12 provided between the electrode layers 2 and the reinforcing layers 3 may not be counted as the slits 12 in the regions 2A and 3A. It may be understandable that the slits 12 are more densely provided in the regions 3A where the reinforcing layers 3 are provided than in the regions 2A where the electrode layers 2 are provided. By increasing the number of the slits 12 in the regions 3A, the electrical resistance of the regions 3A where the reinforcing layers 3 are provided can be increased. As a result, it is possible to prevent the current from being deviated toward the outer peripheral portion of the honeycomb structure 1, so that the entire honeycomb structure 1 can be more uniformly heated. The increase in the number of the slits 12 in the regions 3A is particularly useful when the electrode layers 2 and the reinforcing layers 3 are made of the same material (when it is difficult to adjust the electrical resistivity of the reinforcing layer 3 because of its material).

Next, FIG. 3 is an explanatory view showing an exhaust gas treatment device 300 including the electrically heating support 100 in FIG. 1. As shown in FIG. 3, an electrically heating support 100 according to an embodiment of the present invention can be used in an exhaust gas treatment device 300. The exhaust gas treatment device 300 includes the electrically heating support 100 and a metal can body 310 for holding the honeycomb structure 110 of the electrically heating support 100. The can body 310 may be provided with an opening portion for drawing out a wire 320 connected to electrode terminals 120 to the outside of the can body 310. In the exhaust gas treatment device 300, the electrically heating support 100 may be installed in the middle of an exhaust gas flow path through which an exhaust gas from an engine flows.

In the honeycomb structure 110 according to the present embodiment, the reinforcing layers 3 electrically separated from the pair of electrode layers 2 by the slits 12 are provided on the outer surface of the outer peripheral wall 10 so as to be located between the pair of electrode layers 2 in the circumferential direction 1C of the honeycomb structure portion 1. This allows the honeycomb structure 110 to be reinforced at least at the positions where the reinforcing layers 3 are provided, so that the vertical cracks extending in the axial direction can be suppressed.

Further, since the entire outer circumference of the outer peripheral wall 10 is covered with the electrode layers 2 and the reinforcing layers 3 except for the positions of the plurality of slits 12, the generation of the vertical cracks extending in the axial direction can be suppressed. Further, the outer surface shape of the honeycomb structure 110 can be made smoother, and when canning the honeycomb structure 110 with the metal can body 310, the honeycomb structure 110 can more tightly be canned.

Further, since the electrode layers 2 and the reinforcing layers 3 are made of the same material, the electrode layers 2 and the reinforcing layers 3 can be formed together when producing the honeycomb structure 110, so that the production steps can be further simplified. Further, the thermal expansions of the electrode layer 2 and the reinforcing layer 3 can be matched to each other, the generation of strain due to the difference in expansion between them can be alleviated, and the generation of outer circumferential cracks of the honeycomb structure 110 can be further suppressed.

Further, since the ratio (R2/R1) of the volume resistivity (R2) of the reinforcing layer to the volume resistivity (R1) of the honeycomb structure 1 is more than or equal to 0.0001 and less than or equal to 1, the entire honeycomb structure 1 is can evenly be heated.

Furthermore, since the number of the slits 12 in the regions 3A where the reinforcing layers 3 are provided is larger than the number of the slits 12 in the regions 2A where the electrode layers 2 are provided in the circumferential direction 1C of the honeycomb structure portion 1, it is possible to prevent the current from being deviated toward the outer peripheral portion of the honeycomb structure portion 1, so that the entire honeycomb structure 1 can more uniformly be heated.

### EXAMPLES

The present inventors produced a plurality of honeycomb structures 110 (specimens) shown in Table 1 below, and conducted an electrical conduction performance test and a cooling/heating performance test on them. In Table 1, the honeycomb structures 110 shown as specimen Nos. 3-12 are Examples in which the reinforcing layers 3 are provided as described in the embodiment. Specifically, each of specimen Nos. 3-12 covered the entire outer circumference of the outer peripheral wall 10 with the electrode layers 2 and the reinforcing layers 3 except for the positions of the plurality of slits 12. In each of specimen Nos. 3-12, the materials and/or thicknesses of the electrode layers 2 and the reinforcing layers 3 are changed. More specifically, with respect to specimen No. 3, specimens Nos. 4, 8, 9, and 11 mainly changed the volume resistivity ratio (R2/R1), specimen Nos. 6 and 7 mainly changed the number of the slits in the regions 3A where the reinforcing layers 3 was provided, and specimen Nos. 5, 9, and 12 mainly changed the thicknesses of the electrode layers 2 and the reinforcing layers 3. In specimen Nos. 3-9, the electrode layers 2 and reinforcing layers 3 were made of the same material, but in specimen No. 10, the electrode layers 2 and the reinforcing layers 3 were made of different materials. More specifically, the reinforcing layers 3 of specimen No. 10 was made of an insulator.

On the other hand, the honeycomb structures 110 shown as specimen Nos. 1 and 2 are Comparative Examples that do not have the reinforcing layers 3. As with specimen Nos. 3-8, 10, and 11, specimen No. 1 formed each electrode layer 2 so as to be relatively thin, and as with specimen Nos. 9 and 12, specimen No. 2 formed each electrode layer 2 to be relatively thick. In addition, the substrate portion in a table refers to the honeycomb structure portion 1. Table 1 also shows the volume resistivity of each portion.

TABLE 1

| | | Electrode Layer | | | Reinforcing Layer | | | | | | | |
|---|---|---|---|---|---|---|---|---|---|---|---|---|
| | | | | Number | | | Number of | | | | | |
| | Substrate | | | of Slits | | | Slits | | | Electrical Conduction Heating | | |
| | Portion | | | in Region | | Volume | in Region | | | Distribution (° C.) | | |
| | Volume | | | Where | | Re- | Where | Volume | Cooling/ | Electrode | Directly | Tem- |
| Speci- | Resistivity | Thick- | Volume | Electrode | Thick- | sistivity | Reinforcing | Resistivity | Heating | Layer | Below | perature |
| men | (Ωcm) | ness | Resistivity | Layers Are | ness | (Ωcm) | Layers Are | Ratio | Condition | End | Electrode | Differ- |
| Nos. | R1 | (mm) | (Ωcm) | Provided | (mm) | R2 | Provided | R2/R1 | (° C.) | Portion | Terminal | ence |
| 1 | 100 | 0.23 | 2 | 2 | — | — | 2 | — | 850 | 800 | 500 | 300 |
| 2 | 100 | 5 | 100 | 2 | — | — | 2 | — | 825° C. | 650 | 750 | 100 |
| | | | | | | | | | or less | | | |
| 3 | 100 | 0.23 | 1 | 2 | 0.23 | 1 | 2 | 0.01 | 950 | 1000 | 400 | 800 |
| 4 | 100 | 0.23 | 2 | 2 | 0.23 | 2 | 2 | 0.02 | 950 | 950 | 450 | 500 |
| 5 | 100 | 0.115 | 1 | 2 | 0.115 | 1 | 2 | 0.01 | 950 | 950 | 450 | 500 |
| 6 | 100 | 0.23 | 1 | 2 | 0.23 | 1 | 4 | 0.01 | 950 | 850 | 500 | 350 |
| 7 | 100 | 0.23 | 1 | 2 | 0.23 | 1 | 6 | 0.01 | 950 | 800 | 500 | 300 |
| 8 | 100 | 0.01 | 0.01 | 2 | 0.01 | 0.01 | 6 | 0.0001 | 975 | 850 | 450 | 400 |
| 9 | 100 | 5 | 100 | 2 | 5 | 100 | 2 | 1 | 850 | 650 | 750 | 100 |
| 10 | 100 | 0.23 | 1 | 2 | 0.23 | 100000 | 2 | 1000 | 950 | 800 | 500 | 300 |
| 11 | 100 | 0.01 | 0.005 | 2 | 0.01 | 0.005 | 6 | 0.00005 | 975 | 1200 | 400 | 800 |
| 12 | 100 | 5 | 150 | 2 | 5 | 150 | 2 | 1.5 | 850 | 400 | 900 | 500 |

The electrical conduction performance test was conducted under the following conditions; a voltage of 200V to 400V was applied to the honeycomb structure 110. At this time, the temperatures at the end position 2e (see FIG. 1) of the electrode layer 2 of the honeycomb structure 110 and the directly-below position 2u of the electrode layer 2 (see FIG. 1) (the temperatures at two points showing the maximum temperature during the electrical conduction) was measured to evaluate the deviation of the heat generation deviation for the honeycomb structure 110. When an average temperature of the substrate portion is about 500° C., it is desirable that the maximum temperature (the temperature at the end position 2e of the electrode layer 2) is 1000° C. or less. It should be noted that the temperature at the directly-below position 2u of the electrode layer 2 is preferably 800° C. or less from the viewpoint of protection of the electrode terminals.

The cooling/heating performance test (thermal shock resistance test) was conducted using a propane gas burner tester equipped with a metal case for housing each specimen and a propane gas burner capable of feeding a heating gas into the metal case. The heating gas was a combustion gas generated by burning the propane gas with a gas burner (propane gas burner). Then, the thermal shock resistance was evaluated by confirming whether or not cracks were generated in the specimens by the heating and cooling test as described above.

Specifically, first, each of the resulting specimens was housed (canned) in the metal case of the propane gas burner tester. The gas (combustion gas) heated by the propane gas burner was fed into the metal case so as to pass through the honeycomb structure 110.

The temperature condition of the heating gas flowing into the metal case (inlet gas temperature condition) was set as follows. First, the temperature was increased to the specified temperature in 5 minutes, maintained at the specified temperature for 10 minutes, cooled to 100° C. in 5 minutes, and maintained at 100° C. for 10 minutes. Such a series of operations of increasing, cooling, and maintaining the temperature is refer to as a “heating and cooling operation”. Subsequently, cracks in each specimen were confirmed. Then, the above “heating and cooling operation” was repeated while increasing the specified temperature by 25° C. starting from 825° C. The specified temperature was set in 14 steps by 25° C. starting from 825° C. That is, the above “heating raising and cooling operation” was performed until the specified temperature reached 1150° C. As the specified temperature increases, the steepness of the temperature increase become larger, and the temperature increase of the outer circumference is delayed relative to the central portion, which increases a difference between the temperatures of the central portion and the outer peripheral portion, resulting in large generated stress. In Table 1, the column “Cooling/Heating Condition (° C.)” shows the specified temperature at which cracks were generated in the honeycomb structure 110 in the cooling/heating performance test (thermal shock resistance test).

As shown in Table 1, in specimen No. 1 (Comparative Example), the cooling/heating condition was low, i.e., 850° C. On the other hand, in specimen Nos. 3 to 8, 10, and 11 in which the electrode layers 2 were formed to be relatively thin as in specimen No. 1, the cooling/heating condition was 950° C. or more. It was confirmed from the results that by providing the reinforcing layers 3 on the outer surface of the outer peripheral wall 10 in addition to the electrode layers 2, the generation of vertical cracks extending in the axial direction could be suppressed. Further, the comparison of specimen No. 2 with specimen Nos. 9 and 12, which formed the electrode layers 2 to be relatively thick, also shows that the provision of the reinforcing layers 3 improves the cooling/heating evaluation.

Further, as can be seen from the comparison of specimen No. 8 with specimen No. 11, and the comparison of specimen No. 9 with specimen No. 12, it was confirmed that when the ratio (R2/R1) of the volume resistivity (R2) of the reinforcing layers 3 to the volume resistivity (R1) of the honeycomb structure portion 1 was more than or equal to 0.0001 and less than or equal to 1, the entire honeycomb structure portion 1 could more uniformly be heated. Also, as can be seen from the comparison of specimen No. 3 with specimen Nos. 6 and 7, it was confirmed that when the number of the slits 12 in the regions 3A where the reinforcing layers 3 were provided was larger than the number of the slits 12 in the regions 2A where the electrode layers 2 were provided. the deviation of heat generation was suppressed in the electric conduction heating distribution.

### DESCRIPTION OF REFERENCE NUMERALS

1: honeycomb structure portion
10: outer peripheral wall
11: partition wall
11a: cell
12: slit
13: filling material
2: electrode layer
3: reinforcing layer
100: electrically heating support
110: honeycomb structure
120: electrode terminal
300: exhaust gas treatment devise
310: can body

1. A honeycomb structure comprising:
a honeycomb structure portion made of ceramics, the honeycomb structure portion comprising an outer peripheral wall, a partition wall disposed on an inner side of the outer peripheral wall, the partition wall defining a plurality of cells, each of the cells extending from one end face to other end face to form a flow path, and a plurality of slits cut inwardly in a radial direction from the outer peripheral wall, each of the slits extending in an extending direction of the cells;
a pair of electrode layers used for passing a current into and out of the honeycomb structure, the pair of electrode layers being provided on an outer surface of the outer peripheral wall so as to face each other across a central axis of the honeycomb structure portion; and
reinforcing layers provided on the outer surface of the outer peripheral wall so as to be located between the pair of electrode layers in a circumferential direction of the honeycomb structure portion, the reinforcing layers being electrically separated from the pair of electrode layers by the slits.

2. The honeycomb structure according to claim 1, wherein the entire outer periphery of the outer peripheral wall is covered with the electrode layers and the reinforcing layers except for positions of the plurality of slits.

3. The honeycomb structure according to claim 1, wherein the electrode layers and the reinforcing layers are made of the same material.

4. The honeycomb structure according to claim 1, wherein a ratio (R2/R1) of a volume resistivity (R2) of the reinforcing layers to a volume resistivity (R1) of the honeycomb structure is more than or equal to 0.0001 and less than or equal to 1 or less.

5. The honeycomb structure according to claim 1, wherein the number of the slits in regions where the reinforcing layers are provided is larger than the number of the slits in regions where the electrode layers are provided in the circumferential direction of the honeycomb structure portion.

6. An electrically heating support comprising:
the honeycomb structure according to claim 1; and
electrode terminals provided on the pair of electrode layers.

7. An exhaust gas treatment device comprising:
the electrically heating support according to claim 6; and
a metal can for holding the honeycomb structure.
